(19) United States
(12) Patent Application Publication
(10) Pub. No.: US 2024/0406001 A1
(43) Pub. Date: Dec. 5, 2024

(54) SELF-AUTHENTICATION OF DATA STORED OFF-CHIP

(71) Applicant: Xilinx, Inc., San Jose, CA (US)

(72) Inventors: James David Wesselkamper, Albuquerque, NM (US); Jason Moore, Albuquerque, NM (US); James Bertil Anderson, Madison, AL (US); Thomas LeBoeuf, Sandia Park, NM (US)

(73) Assignee: Xilinx, Inc., San Jose, CA (US)

(21) Appl. No.: 18/204,658

(22) Filed: Jun. 1, 2023

(51) Int. Cl. H04L 9/32; H04L 9/30

(52) U.S. Cl. CPC H04L 9/3247; H04L 9/3073; H04L 9/3242

(57) ABSTRACT

Methods and circuit arrangements for self-authentication of a data set by circuitry on a semi-conductor die include export circuitry and a non-volatile memory disposed on the semiconductor die. The export circuitry is configured to generate a public-private key pair and generate a signature from a data set and a private key of the key pair. The export circuitry is configured to store a version of a public key of the key pair in the non-volatile memory, destroy the private key, and output the data set to external storage.

### TECHNICAL FIELD

The disclosure generally relates to self-authentication by on-chip circuitry of data stored off-chip.

### BACKGROUND

Electronic devices often include one-time programmable, non-volatile memory cells for storage of various types of data. The data can be used for security, configuration, built-in self-test (BIST), and/or built-in self-repair (BISR), for example. Examples of one-time programmable (OTP) memory cells include eFuses and antifuses.

Though the data stored in OTP memory is important for security and desired operation of a device, the OTP memory cells can consume a relatively large area of a semiconductor die depending on the quantity of data to be stored. The area requirements of the OTP memory cells can lead to challenges for fitting circuitry of the main application functions on the die.

### SUMMARY

A disclosed circuit arrangement includes export circuitry and non-volatile memory disposed on a semiconductor die. The export circuitry is coupled to the non-volatile memory and configured to generate a public-private key pair and generate a signature from a data set and a private key of the key pair. The export circuitry is configured to store a version of a public key of the key pair in the non-volatile memory, destroy the private key, and output the data set to external storage.

A disclosed method includes generating a public-private key pair by export circuitry disposed on a semiconductor die and generating a signature from a data set and a private key of the key pair by the export circuitry. The method includes storing a version of a public key of the key pair in non-volatile memory disposed on the semiconductor die and destroying the private key by the export circuitry. The method includes the outputting the data set by the export circuitry to external storage.

Other features will be recognized from consideration of the Detailed Description and Claims, which follow.

### BRIEF DESCRIPTION OF THE DRAWINGS

Various aspects and features of the circuitry and methods will become apparent upon review of the following detailed description and upon reference to the drawings in which:

FIG. 1 shows a system in which an integrated circuit device self-authenticates data for storage off-device;

FIG. 2 shows a flowchart of processing performed by export logic circuitry;

FIG. 3 shows a flowchart of processing performed by import logic circuitry; and

FIG. 4 is a block diagram depicting a System-on-Chip (SoC) in which the disclosed export and import circuitry can be disposed the according to an example.

### DETAILED DESCRIPTION

In the following description, numerous specific details are set forth to describe specific examples presented herein. It should be apparent, however, to one skilled in the art, that one or more other examples and/or variations of these examples, all of which are non-limiting, may be practiced without all the specific details given below. In other instances, well-known features have not been described in detail so as not to obscure the description of the examples herein. For ease of illustration, the same reference numerals may be used in different diagrams to refer to the same elements or additional instances of the same element.

The correct operation of an electronic device can depend on sensitive data that in prior approaches has been stored in non-volatile memory, such as OTP memory cells of the device. The integrity of the data can be of critical importance. For this and other reasons, such data is rarely stored off-chip or off-package. However, as explained above, limited die area can lead to competition for space between the storage for such data and the circuitry that implements the primary functions of the chip/package. “Chip” as used herein refers to a semiconductor die. An “electronic device” (or just “device”) as used herein refers to a semiconductor die or a package of one or more semiconductor dice.

According to the disclosed approaches, circuitry on the device supports off-device storage of sensitive data that has been conventionally stored on-device in non-volatile memory. Export and import circuitry on the device handle authentication of the sensitive data using a public-private key pair. The export circuitry is configured to generate a one-time use public-private key pair, generate a signature over the sensitive data using the private key and validate the signature with the public key. Once validated, the export circuitry stores a version of the public key, such as a hash of the public key, in non-volatile memory of the device and destroys the private key. The data, signature, and public key can then be output for storage external to the device. The import circuitry is configured to input the data, signature, and the public key from external storage, and authenticate the data using the input signature, the input public key, and the version of the public key stored in the non-volatile memory.

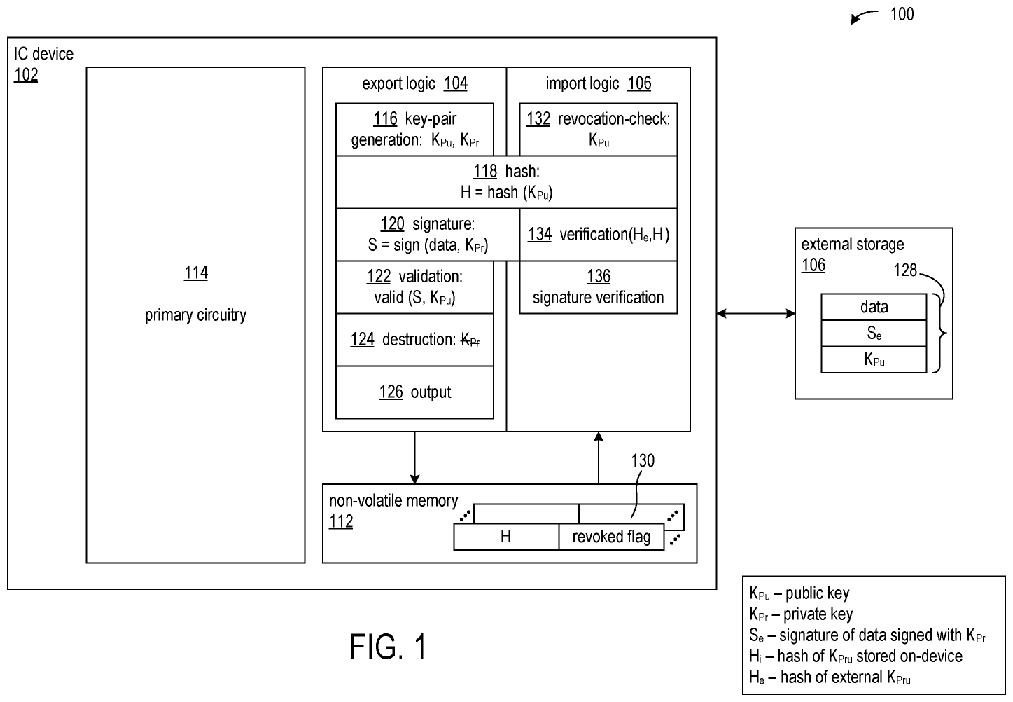

FIG. 1 shows a system in which an integrated circuit device 102, such as a chip or a package, self-authenticates data for storage off-device. The export logic circuitry 104 and import logic circuitry 106 of the device provide self-authentication of the sensitive data for the device, allowing the sensitive data to be stored in external storage 108 instead of in on-device non-volatile memory 112. Exemplary types of the sensitive data include physically unclonable function (PUF) helper data, built-in self-test (BIST), built-in self-repair (BISR), a TRIM command, advanced encryption standard (AES) keys, and/or certificates, etc. The sensitive data can include a combination of plaintext and ciphertext, depending on system requirements.

The exemplary system 100 includes an IC device 102 and external storage 108. The IC device can be a semiconductor die or a package of multiple semiconductor dice. The external storage can be any memory that is external to the IC device and capable of retentively storing the sensitive data. The storage is external to the IC device such that in applications in which the IC device is a single chip, the storage circuitry is not disposed on the same chip as the non-volatile memory. In applications in which the IC device is a package, the external storage is not disposed within the same package as the non-volatile memory 112. The structures and circuitry that implement the external storage can include flash memory, EPROM (erasable programmable read-only memory) and EEPROM (electrically erasable PROM), solid state disks (SSDs), magnetic disks, etc., depending on application requirements for accessing the external storage.

The IC device includes primary circuitry 114, export logic circuitry 104, import logic circuitry 106, and non-volatile memory 112. The primary circuitry includes logic that implements the main functions of the IC device and can include programmable logic, programmable interconnect, processors, transceivers, peripheral interfaces, volatile memory, application-specific circuits, etc.

The non-volatile memory 112 provides on-device storage for data used by the export and import logic circuitry 104 and 106. Examples of non-volatile memory are eFuses, antifuses, flash memory, EPROM (erasable programmable ROM) and EEPROM (electrically erasable programmable ROM). The export and import logic circuitry 104 and 106 are disposed on the same device as the non-volatile memory 112. The functions of the export and import logic circuitry can be implemented by any combination of one or more of hardwired logic, programmable logic, and a programmed microcontroller. Though the export logic and import logic are shown by separate blocks, some logic circuitry can be shared in that some logic circuitry may operate in both domains.

The export logic circuitry generates and validates a signature from the sensitive data and exports the sensitive data, signature and the public key, which is used by the import logic in authentication. The export logic circuitry includes key pair generation logic 116. The key pair generation logic generates a private key and a corresponding public key of a key pair. According to an exemplary approach, the key pair can be generated using the Leighton-Micali Signature algorithm. Alternative algorithms include the RSA (Rivest-Shamir-Adleman) algorithm and the EDCSA (Elliptic Curve Digital Signature Algorithm).

The export logic and import logic can optionally share hash logic 118. The hash logic generates a hash code from the public key. When activated by the export logic, the hash logic generates a hash code from the public key of the generated key pair. When activated by the import logic the hash logic generates a hash code from the imported (from external storage) public key. Examples of hashing algorithms that can be implemented in the hash logic include MD5 (Message Digest) and SHA (Secure Hashing Algorithm).

The signature-generation logic 120 of the export circuitry generates a digital signature from the sensitive data using the private key of the generated key pair and the cryptographic signing algorithm corresponding to the key pair generation algorithm. The sensitive data can be input from an on-device or off-device source, depending on the application. For example, the sensitive data can be PUF helper data that is generated on the IC device, but TRIM and BISR data are defined by off-device sources such as Automated Test Equipment (ATE).

Though signing algorithms, such as Leighton-Micali, are generally stateful in that the implementation needs to store state information associated with the signature, the disclosed approach uses the private key only once. The disclosed approach eliminates the need to store the state information and does not place additional requirements for on-device non-volatile memory as would other approaches.

The validation logic 122 is optional and can use the validation process of the cryptographic signing algorithm for validation using the generated public key of the key pair. In response to the validation process indicating a failure, the export logic circuitry generates a different key pair and again attempts validation.

In response to the validation process indicating successful validation, the destruction logic 124 destroys the generated private key, which disables any re-signing of the data with that private key. The destruction of the private key can entail overwriting the portion of working memory in the export logic allocated to the private key, with any value different from the generated private key.

The output logic 126 stores the hash code version of the public key in the non-volatile memory 112 and outputs the sensitive data, generated signature, and generated public key for retentive storage external to the IC device 102, as shown by data block 128 in external storage 106.

In some applications, the export logic can additionally include encryption logic (not shown) that encrypts the sensitive data before exporting to external storage. An encryption key can be generated by PUF logic or an AES key can be stored in the non-volatile memory.

The export logic circuitry can additionally include logic for revoking a current public key and activating a new public key. The revocation of a public key enables the IC device to recognize that input data is no longer valid as signed by the revoked public key, and thereby avoid a replay attack. According to one approach, the non-volatile memory 112 can have storage space available for hash codes of multiple public keys for a particular sensitive data set, only one of which can be valid for that data set. The validity of each hash code of a public key can be indicated by a bit whose value indicates revoked or not revoked, as exemplified by the revoked flags 130. Alternatively, the revocation status of a hash code of a public key can be indicated overwriting the digest of the key with a predetermined value.

Multiple sensitive data sets can be protected by providing storage space in the non-volatile memory for multiple sets of hash codes of multiple public keys, such that each set of hash codes is associated with one of the sensitive data sets. For example, one set of hash codes can be associated with PUF helper data, another set of hash codes can be associated with BISR data, another set of hash codes can be associated with BIST data, another set of hash codes can be associated with TRIM data, etc.

The import logic circuitry includes revocation-check logic 132. The revocation-check logic inputs the block 128 of sensitive data, signature, and public key. The revocation-check logic checks whether or not the hash code in the non-volatile memory associated with the input public key is revoked. In response to the hash code associated with the input public key being revoked, the revocation-check logic signals that the imported data is invalid.

The import logic circuitry invokes the hash logic 118 to generate a verification hash code (He) from the input public key, and the verification logic 134 reads the associated hash code (Hi) from the non-volatile memory for comparison to the verification hash code. In response to the hash codes not being equal, the verification logic signals that the imported data is invalid.

The signature verification logic 136 invokes the signature logic 120 to produce a verification signature, Sᵥ, from the input data using the public key input from external storage. The signature verification logic generates a signal that indicates whether the data input from external storage is valid or invalid in response to comparison of the verification signature with the signature input from external storage.

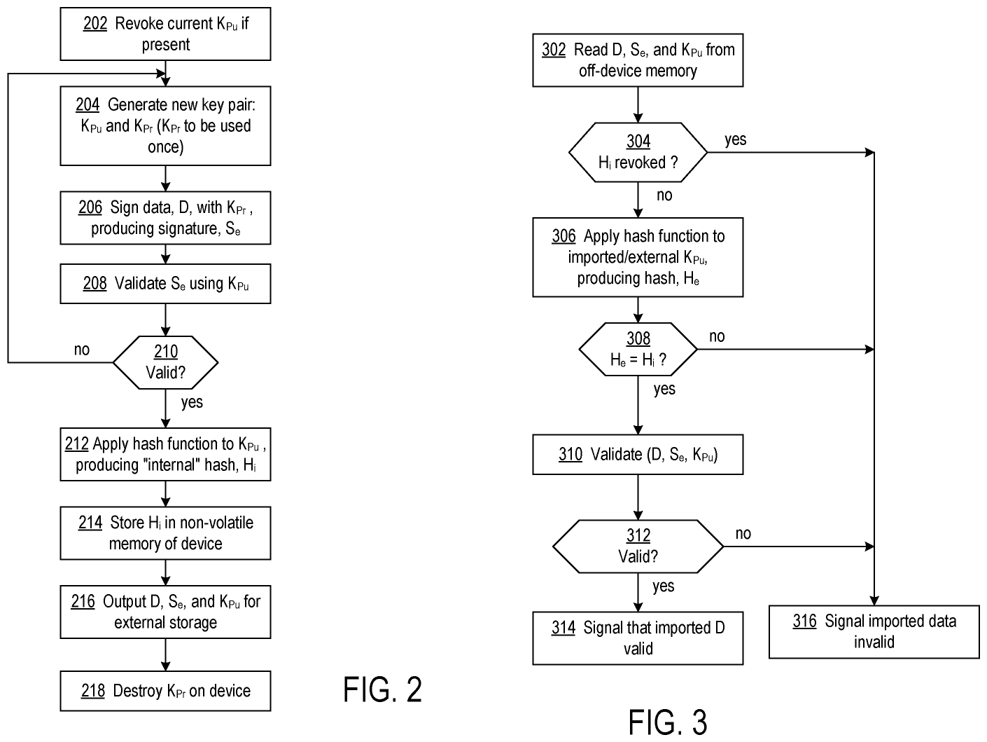

FIG. 2 shows a flowchart of processing performed by the export logic circuitry. At block 202, the export logic circuitry revokes the current public key, K_{Pu}, in response to an entry in the non-volatile memory indicating that the public key is not revoked.

The export logic circuitry at block 204 generates a private key and corresponding public key of a key pair using a key pair generation algorithm such as Leighton-Micali Signature algorithm, RSA algorithm, or the EDCSA. At block 206, the export logic circuitry signs the data, D, using the generated private key according to the chosen cryptographic signing algorithm.

At block 208, the export logic circuitry can use the generated public key of the key pair to optionally validate the generated signature, if required by application objectives. In response to the generated signature failing validation, at decision block 210 the export logic circuitry can return the process to block 204 to generate a different key pair and repeat validation.

In response to the signature being valid, at block 212 the export logic circuitry applies the hash function to the generated public key to generate hash code Hi. At block 214, the export logic circuitry stores the hash code version of the public key in the non-volatile memory 112. The export logic circuitry at block 216 outputs the sensitive data, generated signature, and generated public key for retentive storage external to the IC device.

At block 218, the export logic circuitry destroys the generated private key, which disables any re-signing of the data with that private key. The destruction of the private key can entail overwriting the portion of working memory in the export logic allocated to the private key, with any value different from the generated private key.

FIG. 3 shows a flowchart of processing performed by the import logic circuitry. At block 302, the import logic circuitry inputs the data, signature, and public key from external storage. The import logic circuitry determines at decision block 304 whether or not the internal hash code, Hi, corresponding to the input public key has been revoked. In response to the hash code associated with the input public key being revoked, the import logic circuitry signals that the imported data is invalid at block 316.

At block 306, the import logic circuitry applies the hash function to the input public key to generate a verification hash code, He. The import logic circuitry reads the internal hash code, Hi, of the current public key from the non-volatile memory for comparison to the verification hash code at decision block 308. In response to the internal hash code Hi, being not equal to the verification hash code, He, the import logic circuitry signals that the imported data is invalid at block 316.

At block 310, the import logic circuitry performs a validation process of the cryptographic signing algorithm on the data set and associated public key and signature input from external storage. For example, RSA/ECDSA cryptographic signing algorithms check that a hash code generated from operations on the verification signature matches the hash code of the message, and the LMS algorithm verifies that a digest based on operations on the verification signature matches the public key, K_{Pu}. In response to the validation process indicating that the imported data is valid, decision block 312 directs the process to block 314 for the import logic circuitry to generate a signal indicating that the data input from external storage is valid. In response to the validation process indicating that the imported data is invalid, decision block 312 directs the process to block 316 for the import logic circuitry to generate a signal indicating that the data input from external storage is invalid.

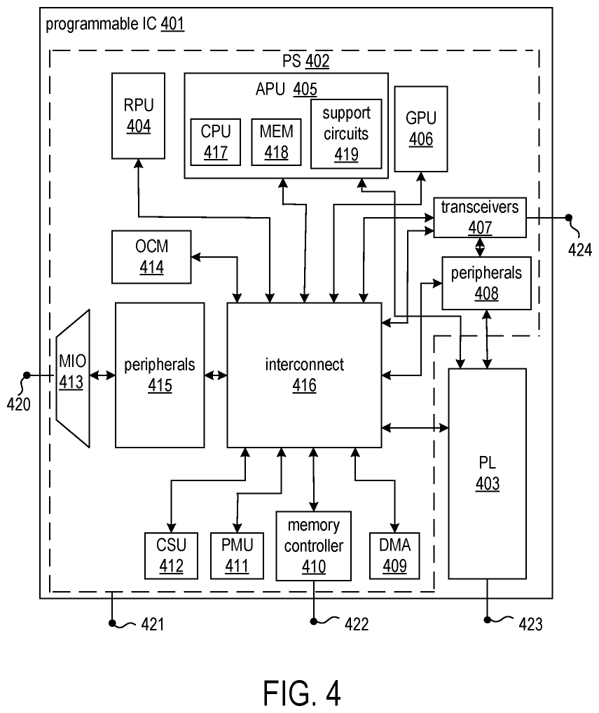

FIG. 4 is a block diagram depicting a System-on-Chip (SoC) 401 or system-in package (SiP) in which the disclosed export and import circuitry can be disposed the according to an example. In the example, the SoC includes the processing subsystem (PS) 402 and the programmable logic subsystem 403. The processing subsystem 402 includes various processing units, such as a real-time processing unit (RPU) 404, an application processing unit (APU) 405, a graphics processing unit (GPU) 406, a configuration and security unit (CSU) 412, and a platform management unit (PMU) 411. According to an example, export and import logic circuitry can be components within the PMU 411. The PS 402 also includes various support circuits, such as on-chip memory (OCM) 414, transceivers 407, peripherals 408, interconnect 416, DMA circuit 409, memory controller 410, peripherals 415, and multiplexed (MIO) circuit 413. The processing units and the support circuits are interconnected by the interconnect 416. The PL subsystem 403 is also coupled to the interconnect 416. The transceivers 407 are coupled to external pins 424. The PL 403 is coupled to external pins 423. The memory controller 410 is coupled to external pins 422. The MIO 413 is coupled to external pins 420. The PS 402 is generally coupled to external pins 421. The APU 405 can include a CPU 417, memory 418, and support circuits 419. The APU 405 can include other circuitry, including L1 and L2 caches and the like. The RPU 404 can include additional circuitry, such as L1 caches and the like. The interconnect 416 can include cache-coherent interconnect or the like.

Referring to the PS 402, each of the processing units includes one or more central processing units (CPUs) and associated circuits, such as memories, interrupt controllers, direct memory access (DMA) controllers, memory management units (MMUs), floating point units (FPUs), and the like. The interconnect 416 includes various switches, busses, communication links, and the like configured to interconnect the processing units, as well as interconnect the other components in the PS 402 to the processing units.

The OCM 414 includes one or more RAM modules, which can be distributed throughout the PS 402. For example, the OCM 414 can include battery backed RAM (BBRAM), tightly coupled memory (TCM), and the like. The memory controller 410 can include a DRAM interface for accessing external DRAM. The peripherals 408, 415 can include one or more components that provide an interface to the PS 402. For example, the peripherals can include a graphics processing unit (GPU), a display interface (e.g., DisplayPort, high-definition multimedia interface (HDMI) port, etc.), universal serial bus (USB) ports, Ethernet ports, universal asynchronous transceiver (UART) ports, serial peripheral interface (SPI) ports, general purpose (GPIO) ports, serial advanced technology attachment (SATA) ports, PCIe ports, and the like. The peripherals 415 can be coupled to the MIO 413. The peripherals 408 can be coupled to the transceivers 407. The transceivers 407 can include serializer/deserializer (SERDES) circuits, MGTs, and the like.

Various logic may be implemented as circuitry to carry out one or more of the operations and activities described herein and/or shown in the figures. In these contexts, a circuit or circuitry may be referred to as “logic,” “module,” “engine,” “unit,” or “block.” It should be understood that elements labeled by these terms are all circuits that carry out one or more of the operations/activities. In certain implementations, a programmable circuit is one or more computer circuits programmed to execute a set (or sets) of instructions stored in a ROM or RAM and/or operate according to configuration data stored in a configuration memory.

Those skilled in the art will appreciate that various alternative computing arrangements, including one or more processors and a memory arrangement configured with program code, would be suitable for hosting the processes and data structures disclosed herein. In addition, the processes may be provided via a variety of computer-readable storage media or delivery channels such as magnetic or optical disks or tapes, electronic storage devices, or as application services over a network.

Though aspects and features may in some cases be described in individual figures, it will be appreciated that features from one figure can be combined with features of another figure even though the combination is not explicitly shown or explicitly described as a combination.

The circuitry and methods are thought to be applicable to a variety of systems for authentication of important data. Other aspects and features will be apparent to those skilled in the art from consideration of the specification. The circuitry and methods may be implemented as one or more processors configured to execute software, as an application specific integrated circuit (ASIC), or as a logic on a programmable logic device. It is intended that the specification and drawings be considered as examples only, with a true scope of the invention being indicated by the following claims.

What is claimed is:

1. A circuit arrangement comprising:
non-volatile memory disposed on a semiconductor die; and
export circuitry disposed on the semiconductor die and coupled to the non-volatile memory, wherein the export circuitry is configured to:
generate a public-private key pair;
generate a signature from a data set and a private key of the key pair;
store a version of a public key of the key pair in the non-volatile memory;
destroy the private key; and
output the data set to external storage.

2. The circuit arrangement of claim 1, wherein the export circuitry is configured to output the public key to the external storage.

3. The circuit arrangement of claim 1, wherein the export circuitry is configured to generate a hash code from the public key, and the hash code is the version of the public key.

4. The circuit arrangement of claim 1, wherein the export circuitry is configured to output the signature to the external storage.

5. The circuit arrangement of claim 1, wherein the export circuitry is configured to:
indicate in the non-volatile memory whether the version of the public key in the non-volatile memory is valid or invalid; and
generate a new key pair in response to an invalid indication of the version of the public key.

6. The circuit arrangement of claim 1, further comprising import circuitry disposed on the semiconductor die and coupled to the non-volatile memory, wherein:
the export circuitry is configured to output the public key and the signature to the external storage; and
the import circuitry is configured to:
input the data set, the signature, and the public key from the external storage, and
authenticate the data set input from the external storage using the signature and the public key input from the external storage and the version of the public key stored in the non-volatile memory.

7. The circuit arrangement of claim 6, wherein:
the export circuitry is configured to generate a hash code from the public key, and the hash code is the version of the public key; and
the import circuitry is configured to:
generate a verification hash code from the public key input from the external storage, and
signal that the data set input from the external storage is invalid in response to the verification hash code not matching the hash code in the non-volatile memory.

8. The circuit arrangement of claim 6, wherein:
the export circuitry is configured to generate the signature using a cryptographic signing algorithm; and
the import circuitry is configured to:
determine whether the data set input from the external storage is valid or invalid using a validation process of the cryptographic signing algorithm on the data set, the signature, and the public key input from the external storage; and
generate a signal that indicates whether the data set input from the external storage is valid or invalid.

9. The circuit arrangement of claim 6, wherein:
the export circuitry is configured to indicate in the non-volatile memory whether the version of the public key in the non-volatile memory is valid or invalid; and
the import circuitry is configured to signal that the data set input from the external storage is invalid in response to an invalid indication of the version of the public key.

10. The circuit arrangement of claim 1, wherein the export circuitry is configured to validate the signature with the public key of the key pair.

11. A method comprising:
generating a public-private key pair by export circuitry disposed on a semiconductor die;
generating a signature from a data set and a private key of the key pair by the export circuitry;
storing a version of a public key of the key pair in non-volatile memory disposed on the semiconductor die;
destroying the private key by the export circuitry; and
outputting the data set by the export circuitry to external storage.

12. The method of claim 11, further comprising outputting the public key to the external storage by the export circuitry.

13. The method of claim 11, further comprising generating a hash code from the public key by the export circuitry, wherein the hash code is the version of the public key.

14. The method of claim 11, further comprising outputting the signature to the external storage by the export circuitry.

15. The method of claim 11, further comprising:
indicating in the non-volatile memory whether the version of the public key in the non-volatile memory is valid or invalid; and
generating a new key pair by the export circuitry in response to an invalid indication of the version of the public key.

16. The method of claim 11, further comprising:
outputting the public key and the signature to the external storage by the export circuitry;
inputting the data set, the signature, and the public key from the external storage by import circuitry disposed on the semiconductor die; and
authenticating the data set input from the external storage by the import circuitry using the signature and the public key input from the external storage and the version of the public key stored in the non-volatile memory.

17. The method of claim 16, further comprising:
generating a hash code from the public key by the export circuitry, wherein the hash code is the version of the public key;
generating a verification hash code from the public key input from the external storage by the import circuitry; and
signaling that the data set input from the external storage is invalid by the import circuitry in response to the verification hash code not matching the hash code in the non-volatile memory.

18. The method of claim 16, further comprising:
generating the signature by the export circuitry using a cryptographic signing algorithm;
determining whether the data set input from the external storage is valid or invalid by the import circuitry using a validation process of the cryptographic signing algorithm on the data set, the signature, and public key input from external storage; and
generating a signal that indicates whether the data set input from the external storage is valid or invalid.

19. The method of claim 16, further comprising:
indicating in the non-volatile memory whether the version of the public key in the non-volatile memory is valid or invalid by the export circuitry; and
signaling that the data set input from the external storage is invalid by the import circuitry in response to an invalid indication of the version of the public key.

20. The method of claim 11, further comprising validating the signature with the public key of the key pair by the export circuitry.
